(19) United States
(12) Patent Application Publication
(10) Pub. No.: US 2019/0381944 A1
(43) Pub. Date: Dec. 19, 2019

(54) Lift System for Roof-Mounted Storage on Vehicles

(71) Applicant: Michael D. Ellenbogen, Brooklyn, NY (US)

(72) Inventor: Michael D. Ellenbogen, Brooklyn, NY (US)

(21) Appl. No.: 16/388,019

(22) Filed: Apr. 18, 2019

Related U.S. Application Data
(62) Division of application No. 16/006,987, filed on Jun. 13, 2018.

(51) Int. Cl. B60R 9/042; B60R 9/06

(52) U.S. Cl. CPC B60R 9/042; B60R 9/06

(57) ABSTRACT

The invention relates to a lift system to selectively raise and lower an interchangeable load carrier, such as a bike rack, luggage rack, ski rack, etc., to and from the roof of a vehicle to the ground. The lift system is capable of creating a clearance, either vertically or horizontally, between the roof of a vehicle and the load carrier. As a result, the load carrier can be lowered and raised without hitting the vehicle. The lift system may also be provided with a series of actuators that are configured for synchronized rotation in order to keep the load carrier in a constant orientation as it is raised and lowered to and from the vehicle.

### PRIORITY

This application claims the benefit of provisional application 62/519,241 filed on 14 Jun. 2017, provisional applications 62/479,498 and 62/479,484 filed on 31 Mar. 2017, and provisional application 62/372,244 filed on 16 Mar. 2017.

### TECHNICAL FIELD

The invention relates to a lift system and load carrier for automobile vehicles. More particularly, the invention relates to a lift system and load carrier capable creating a clearance, either manually or automatically, between the roof of an automobile vehicle and the load carrier, so that the load carrier may be raised or lowered from the roof of the automobile vehicle to the ground.

### BACKGROUND OF THE INVENTION

Roof-mounted load carriers for vehicles are well known. Traditionally, these carriers are mounted directly to the roof of a vehicle in a stationary manner, and require an individual to manually lift any object intended to be stored or held on the roof of a vehicle. Requiring an individual to raise and secure objects on the roof of the vehicle from the ground can be difficult.

Movable roof-mounted load carriers are also well known, which alleviate some of the problems of stationary roof-mounted load carriers. These carriers generally fall into two categories: (1) rear-loaded systems; or (2) side-loaded systems.

Rear-loaded systems allow a user to secure or store objects while the load carrier is behind the vehicle, and the load carrier is then raised, either through brackets or other means, to the roof of the vehicle. U.S. Pat. No. 6,827,244 shows a load carrier that allows for securing of objects from the rear of a vehicle, which can subsequently be lifted to the roof of the vehicle. However, the system must be mounted to the roof of the vehicle, making it difficult to attach and detach the system from the vehicle. Further, the system does not give a user full access to the load carrier (i.e. the object must still be manipulated and secured at an angle), it requires the user to slide the potentially heavy load, which also rubs against the vehicle, and the system blocks the trunk from being opened when in the rear-loading position. U.S. Pat. No. 7,469,806 is another rear-loaded system that alleviates some of these problems, but it also has shortcomings. While the system gives a user full access to the load carrier, the user must manually rotate large and potentially heavy loads to the roof of the vehicle. Further, the system requires a large extension from the rear of the vehicle to give the system enough clearance to rotate the load carrier to the roof. This essentially makes the vehicle substantially longer than it would otherwise be, which may pose difficulties while driving.

Side-loaded systems allow a user to secure or store objects while the load carrier is to the side of the vehicle, and the load carrier is then raised, either through brackets or other means, to the roof of the vehicle. For instance, U.S. Pat. Nos. 4,003,485 and 5,360,151 both show systems that enable individuals to lift objects from the ground to the roof of a vehicle from the side of the vehicle. However, both systems must be mounted to the roof of the vehicle, making it difficult to attach and detach the systems to and from the vehicle, and both systems require an individual to manually lift potentially heavy loads.

The present system alleviates many of the shortcomings of the prior art by providing a lift system that raises a load carrier from either the rear or side of a vehicle to the roof. Such a system may be easily attached and detached to the vehicle using a standard vehicle hitch. The lift system saves space by having the ability to increase the relative height between the load carrier and roof of the vehicle so that the load carrier may clear the roof of the vehicle during rotation to and from the ground without using large, permanent, mechanical extensions. Further, while the lift system may be manual, the system preferably has motors or other means to automatically lift heavy loads from the ground to the roof of a vehicle. Finally, the lift system is provided with a connection mechanism allowing for an individual to easily change the type of load carrier, allowing individuals to use the lift system with cargo, skis, bikes, canoes, kayaks, wheel chairs, furniture etc., but it is not limited to the abovementioned.

### SUMMARY OF THE INVENTION

In a first embodiment of the invention, a telescoping lift system is described. One end of the telescoping lift system connects to a vehicle, while the other end of the lift system connects to a load carrier mechanism. The load carrier mechanism can be a multitude of structures capable of holding, storing, or securing luggage, skis, bikes, canoes, kayaks, wheel chairs, furniture etc. For instance, in one embodiment, a bike rack may be attached to the lift system. The bike rack may then be exchanged, and a cargo carrier may be attached to the lift system. Each different type of load carrier may be interchanged via a connection mechanism, such as a clip connection, threaded connection, dead bolt connection, pin connection, or any other type of connection. The connection mechanism may be manual or automatic.

In the first embodiment of the invention, the lift system has or is attached to the vehicle hitch by means of a hinge adapted to rotate in a side-to-side arrangement along a plane normal to the hitch mechanism on the vehicle. Similarly, the other end of the lift system has or is attached to the load carrier by means of a hinge adapted to rotate in a side-to-side arrangement along a plane normal to the hitch mechanism on the vehicle. The lift system is capable of moving one member relative to another in a telescoping manner, thereby allowing the load carrier to have enough clearance between it and a vehicle when moving from a position substantially close to the ground to a position above the vehicle. Any of the hinge points and or telescopic arm may also include a motor in order to automate the rotation or relative movement of each connection point. In one non-limiting example of the invention's use, if an individual has previously packed and stored luggage in a cargo container on the roof of a vehicle and wishes to access the cargo container's contents, a motor attached to the telescopic member may be activated to raise the load carrier holding the cargo container relative to the vehicle. The two hinge motors may then activate, with the hinge by the hitch rotating to lower the cargo container from above the vehicle to the ground along either side of the vehicle. The hinge by the connection mechanism with the load carrier (i.e. cargo container) would counter-rotate to keep the cargo container parallel to the ground, so as to not disturb the contents of the container.

In a second embodiment of the invention, the clearance height between the vehicle and load carrier may be achieved not through a telescoping relationship, but by one or more additional hinge points that may rotate relative to each other to adjust the relative height between the load carrier and the vehicle.

In a third embodiment of the invention, a telescoping lift system utilizes hinges by the hitch mechanism and load carrier that rotate in a plane parallel to the hitch mechanism. Such rotation thereby allows a load carrier to be lifted and lowered behind a vehicle.

In a fourth embodiment of the invention, the clearance height between the vehicle and load carrier may be achieved not through a telescoping relationship, but by offsetting the location of the hinge relative to the hitch. For instance, an extension member may extend from the hitch mechanism of the vehicle towards one side of the vehicle. At the other end of the extension member, the first member of the lift system may be attached to the extension member by means of a hinge. As a result, when the load carrier is oriented on the roof of the car, the first member is not perpendicular to the ground, but is rather at an angle relative to the ground. Clearance is achieved by first rotating the first member to a perpendicular position, and then continuing rotation until the load carrier is oriented by the ground. Alternatively, the lift mechanism may not even utilize the vehicle hitch at all, and may be attached to the vehicle closer to one side of the vehicle than the other. Such a configuration would eliminate the need for the extension member to offset the lift system from the center of the vehicle.

In a fifth embodiment of the invention, the first member may be attached to the hitch mechanism by means of a hinge that rotates along an axis perpendicular to the ground. In this embodiment, it is not necessary to create clearance between the vehicle and the load carrier. Instead, the entire load carrier system is rotated about an axis substantially perpendicular to the ground by means of the first member. The load carrier may then be lowered closer to the ground by means of a telescoping mechanism, a screw mechanism, a slide mechanism, or any other mechanism.

In a sixth embodiment of the invention, the second member may be in the form of a parallelogram, where two base arms are parallel and connected on their ends by two parallel pivot arms. The two pivot arms are capable of rotating (while maintaining parallelism) relative to the base arms, which selectively raises and lowers the load carrier.

Any embodiment may utilize a second lift system attached to either the front or rear of a vehicle, wherein the two lift systems work simultaneously to lift and lower the load carrier, enabling heavier loads to be lifted.

All of the embodiments of the lift system may also include a computer-programmable controller to control the lifting system. The computer-programmable controller may be located in the vehicle, lift system, or any other place, such as a hand-held personal communication device, that would enable an individual to control the lifting system to lift or lower the load carrier to or from the roof of the vehicle to the ground. In one non-limiting embodiment, the controller may be located on a device that communicates to the vehicle or lifting system via infrared, Bluetooth, cellular data, Wi-Fi, radio waves, or any other wireless communication protocol. However, these examples should not be construed as limiting the inventive concept to any particular physical configuration. As those skilled in the arts will understand, a suitable remote computer programmable controller with buttons can be fabricated in a variety of different ways.

All of the embodiments of the lift system may utilize manual or automatic connections and hinges. While the invention is described as using motors, and more particularly servomotors, alternative embodiments may utilize other actuation means, such as shocks, springs, electric and air motors, direct drive actuators, pistons, geared or non-geared crank mechanisms, or any other actuation means. Any of the embodiments may utilize manual or electric systems, or a combination of the above, but are not limited to the aforementioned actuators. When connecting the load carrier to the lift system, any type of connection may be used, including but not limited to a clip or buckle connection, threaded connection, dead bolt connection, or any other type of connection. The connection mechanism may be manual or automatic, such as a motor-activated dead bolt connection.

All the embodiments of the lift system may utilize a plurality of struts to attach the lift system to a vehicle, or may utilize a plurality of telescoping members, a plurality of connection mechanisms between the load carrier and the lift system, a plurality of load carriers, a plurality of receiver hitches, or the like. Furthermore, the struts and/or hitches may be welded to the frame of the vehicle. It should be kept in mind that the above described text and embodiments are only presented by way of example and should not be construed as limiting the inventive concept to any particular mechanical or physical configuration.

The lift system and load carrier arrangement may be utilized on many vehicles, such as cars, vans, motorcycles, All-Terrain-Vehicles (ATVs), boats, trucks, trains, trailers, or any other personal, commercial, or military vehicles. All of the lift system embodiments may be secured to a vehicle by utilizing a hitch, or by adding, welding, bolting, or otherwise attaching the lift system to the vehicle.

Any of the embodiments may also include an audible and visual system. For instance, such a system may be attached to the tail-light controllers of a vehicle, enabling the illumination of tail lights, turn signals, and brake lights that may be located on the lift system. Alternatively, the system may be controlled by another controller, such as the programmable computer controller located in the vehicle, lift system, or remote device, as discussed previously. The system may also give an audible or visual warning to pedestrians when the vehicle is backing up, or warn operators or pedestrians of the impending operation of the lift system.

### BRIEF DESCRIPTION OF THE DRAWINGS

FIG. 1A-B shows a side-view of a telescoping lift system both attached to and detached from a vehicle.

FIG. 2A-B shows a rear-view of the telescoping lift system of FIG. 1, with the telescoping members extended to create a clearance between the load carrier and vehicle, and compacted to rest the load carrier on the roof of the vehicle.

FIG. 3 shows a side-view of the telescoping lift system of FIG. 1, with the telescoping members extended to create a clearance between the load carrier and vehicle.

FIG. 4 shows a rear-view of the telescoping lift system of FIG. 1, wherein the members are rotated along a plane normal to the hitch of the vehicle to lower the load carrier from the roof of the vehicle to the ground.

FIG. 5 shows a rear-view of the telescoping lift system of FIG. 1, wherein the members have been fully rotated so that the load carrier is substantially near the ground.

FIG. 6 shows a side-view of the telescoping lift system of FIG. 1, wherein the members have been fully rotated so that the load carrier is substantially near the ground.

FIG. 7A-B show a rear-view of an alternative embodiment of the invention, wherein additional members and hinges are utilized to generate clearance between the load carrier and vehicle.

FIG. 8A-B show a side-view of an alternative embodiment of the invention, wherein the telescoping lift system utilizes hinges by the hitch mechanism and load carrier that rotate in a plane parallel to the hitch mechanism, thereby allowing a load carrier to be lifted and lowered behind a vehicle.

FIG. 9 shows a side-view of the alternative embodiment of FIG. 8, wherein the system is attached to the vehicle and the load carrier is attached to the system by means of a dead bolt connection and the telescoping members are extended to create clearance between the load carrier and vehicle.

FIG. 10 shows a side-view of the alternative embodiment of FIG. 8, wherein the members are rotated along a plane parallel to the hitch mechanism of the vehicle to lower the load carrier from the roof of the vehicle to the ground.

FIG. 11 shows a side-view of the alternative embodiment of FIG. 8, wherein the members have been fully rotated so that the load carrier is substantially near the ground.

FIG. 12 shows a side-view of an alternative embodiment of the invention, wherein two lift systems are provided; one for the front and one for the rear of the vehicle.

FIG. 13 shows a side-view of the alternative embodiment of FIG. 12, wherein the two lift systems are attached to a vehicle.

FIG. 14 shows a side-view of the alternative embodiment of FIG. 12, wherein two telescoping lift systems are extended to create a clearance between the load carrier and vehicle.

FIG. 15 shows a side-view of the alternative embodiment of FIG. 12, wherein the members of the two lift systems have been fully rotated so that the load carrier is substantially near the ground.

FIG. 16 shows a rear-view of an alternative embodiment of the invention, wherein the lift system utilizes a hinge offset from the center of the car.

FIG. 17 shows a rear-view of the alternative embodiment of FIG. 16, wherein the member is partially rotated to create clearance between the load carrier and the roof of the vehicle.

FIG. 18 shows a rear-view of the alternative embodiment of FIG. 16, wherein the member is fully rotated so that the load carrier is substantially near the ground.

FIG. 19 shows a side-view of the alternative embodiment of the invention, wherein the load carrier revolves around an axis passing through the member, normal to the ground.

FIG. 20 shows a side-view of the alternative embodiment of FIG. 19, wherein the member is telescopically extended to create a clearance between the load carrier and the vehicle.

FIG. 21 shows a side-view of the alternative embodiment of FIG. 19, wherein the member is telescopically extended and the load carrier has revolved about the axis normal to the ground.

FIG. 22 shows a side-view of the alternative embodiment of FIG. 19, wherein the member is telescopically compacted so that the load carrier is substantially near the ground.

FIG. 23A-B show a side-view of the alternative embodiment of the invention, wherein load carrier is raised and lowered via a screw-type member.

FIG. 24 shows a side-view of the alternative embodiment of FIG. 23, wherein the screw-type member is extended to create a clearance between the load carrier and the vehicle.

FIG. 25 shows a side-view of the alternative embodiment of FIG. 23, wherein the screw-type member is extended and the load carrier has revolved about the axis normal to the ground.

FIG. 26 shows a side-view of the alternative embodiment of FIG. 23, wherein the screw-type member has lowered the load carrier substantially near the ground.

FIG. 27 shows a rear-view of an alternative embodiment of the invention, wherein the second member has a plurality of arms, forming a parallelogram-type shape.

FIG. 28 shows a rear-view of an alternative embodiment of FIG. 27, wherein the second member is actuated.

### DETAILED DESCRIPTION

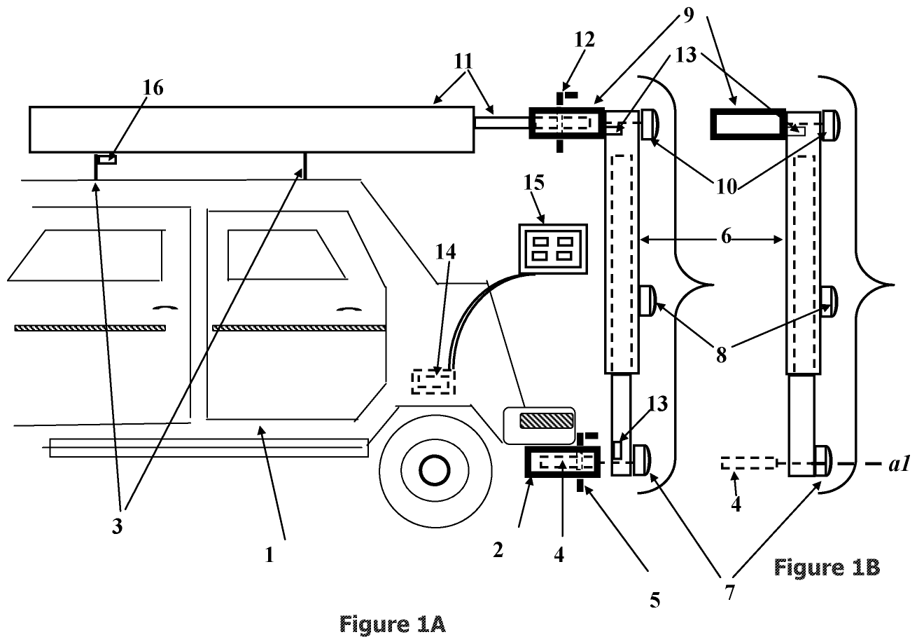

FIG. 1A shows an embodiment of a telescoping lift system attached to a vehicle 1, having a rear-mounted hitch 2 and roof rack 3. FIG. 1B shows the same lift system detached from the vehicle 1. The lift system is dimensioned so that it protrudes minimally from the back of the vehicle 1. The lift system has an attachment mechanism 4 with an axis a1. The attachment mechanism 4 may be a standard hitch shank that mounts directly onto or into the vehicle hitch via a corresponding male/female relationship, and are secured together by means of a hitch pin 5. While such a connection is utilized in this embodiment, any connection mechanism may be used. The lift system has a telescopic arm 6 having at least two members engaged in a telescoping relationship. The members of the telescopic arm may move relative to one other, such as by means of a servomotor 8, so as to lengthen or shorten the telescopic arm. The servomotor 8 may be mounted in a stationary manner relative to one member of the telescopic arm 8, while being mounted in a dynamic manner relative to another member of the arm 8. For instance, the servomotor 8 may rotate a gear with teeth which engages gear grooves on the dynamic member of the telescopic arm 8, moving the dynamic member relative to the stationary member. However, such relative motion may be accomplished in many ways, including threaded engagements, track systems, pneumatics, friction, pulley-and-cable system, piston, screw jack, etc.

The telescopic arm 6 is attached to the hitch shank 4 in a way that enables rotation of the telescopic arm relative to the hitch shank 4. Such rotation may be accomplished through a servomotor 7 attached near or between the hitch shank 4 and base of the telescopic arm 6. Alternatively, the telescopic arm 6 may be attached directly to the hitch shank 4 by means of a hinge connection, with an adjacent servomotor 7 controlling the rotational movement of the telescopic arm 6.

A connection mechanism 9 intended to connect to an interchangeable load carrier 11 is attached to the top of the telescopic arm 6 in a way that enables rotation of the connection mechanism 9 and load carrier 11 relative to the telescopic arm 6. In one non-limiting example, such rotation may be accomplished through a servomotor 10 attached near or between the connection mechanism 9 and top of the telescopic arm 6. In an alternative non-limiting example, the connection mechanism 9 may be attached directly to the telescopic arm 6 by means of a hinge connection, with an adjacent servomotor 10 controlling the rotational movement of the connection mechanism 9. The servomotor 10 causes the connection mechanism 9 and load carrier 11 to rotate about an axis perpendicular to the telescopic arm 6. In use, the servomotors 7, 10 may be attached to their respective ends of the telescopic arm 6, and may be rotated in a synchronized counter-rotational way relative to each other, such that the telescopic arm 6 rotates in one direction while the connection mechanism 9 rotates in the counter-rotational direction, thereby keeping the interchangeable load carrier 11 substantially parallel to the ground (i.e. the interchangeable load carrier 11 is oriented in the same way both on the ground and on the roof of the car) while the lift system raises or lowers the interchangeable load carrier 11. However, the servomotors 7, 10, may achieve this counter-rotational function in other ways as well, such as by having the servomotors 7, 10 rotate in the same direction, but have the motors 7, 10 oriented in opposite directions.

The interchangeable load carrier 11 is attached to the connection mechanism 9 by means of a male/female hitch connection, secured by a hitch pin 12. However, any other type of connection may be used. The connection mechanism 9 does not rotate relative to the load carrier 11. Such rotation may be prevented by, for example, utilizing square-shaped tubing, or any shape utilizing corners that prevent rotation. Alternative, the tubing may be substantially cylindrical, while utilizing a key relationship to prevent rotation. However, rotation may be prevented by any other means. In fact, it is possible to have a single, integrated load carrier and connection mechanism if the load carrier is not intended to be interchangeable.

A detachable, interchangeable load carrier 11, with a rigidly connected hitch shank, provides a means for easily loading and unloading various cargo into or onto it, and the opportunity to change, insert and engage various different detachable, interchangeable load carrier to the lift system. For instance, the interchangeable load carrier may be a cargo container, a ski or snowboard rack, a bicycle rack, a canoe or kayak rack, or attachment means for wheel chairs, furniture, signage, billboard, drone-launching etc., but it is not limited to the abovementioned.

The lift system and/or interchangeable load carrier 11 may also utilize locking means. Such locking means would be a way of securing various components from accidental movement. For instance, the lift system may be provided with at least one solenoid-operated dead bolt lock 13, which could lock the lift system at a particular angle, or the telescoping arm 6 at a particular height. The interchangeable load carrier 11 may also be provided with at least one solenoid-operated dead bolt lock 16 to secure the interchangeable load carrier 11 to the roof of the vehicle 1 or vehicle rack 3. Although this embodiment envisions, in particular, solenoid-operated dead bolt locks 13, 16, any other type of locking mechanism may be used.

The lift system may be provided with a computer-programmable controller 15 comprising a module 14. The computer-programmable controller 15 may be located in the vehicle 1, lift system, or any other place, such as a hand-held personal communication device, that would enable an individual to control the lift system to lift or lower the load carrier 11 to or from the roof of the vehicle 1 to the ground. The controller 15 may communicate to the lift system, particularly the servomotors 7, 8, 10, solenoid-operated locks 13, 16, or any other hardware directly, such as through wires, or through wireless communications, such as infrared, Bluetooth, cellular data, Wi-Fi, radio waves, or any other wireless communication protocol. The controller 15 may have means, such as physical or digital buttons, of interacting with the module 14. The module 14 may be a CPU and/or other hardware located on the vehicle or lift system, without any means of directly interacting with the module 14, while the controller 15 is on a hand-held personal communication device, allowing an individual to interact with the module 14 via wireless communication means.

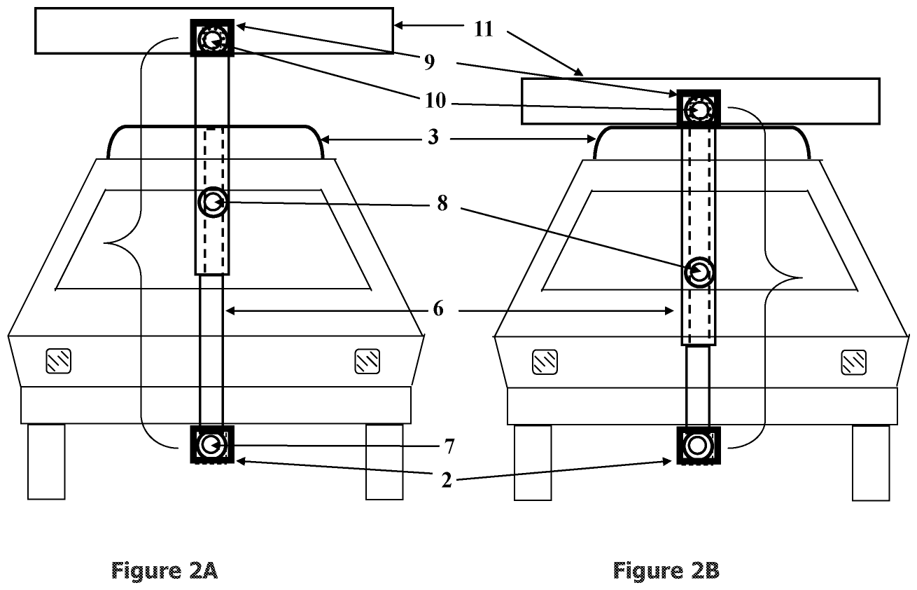

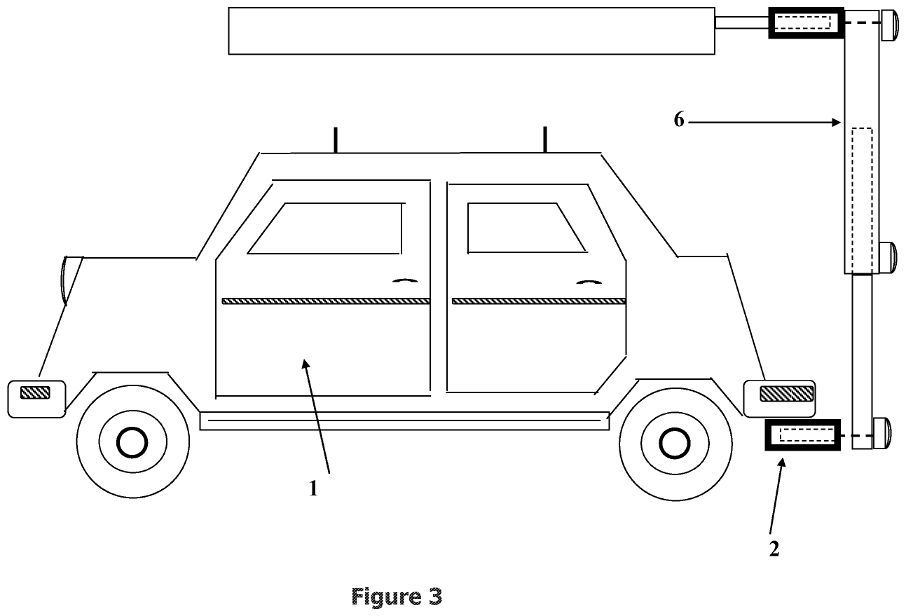

FIG. 2A shows a rear-view of the invention in operation, where the telescopic arm 6 has been extended to create a clearance between the load carrier 11 and the roof of the vehicle 1. Such clearance is created by activating the servomotor 8 to move one member of the telescopic arm 6 relative another member of the telescopic arm 6, thereby increasing the overall length of the telescopic arm 6. FIG. 2B then shows a rear view of the invention where the telescopic arm 6 has been partially compacted such that the load carrier 11 rests on the roof of the vehicle 1. FIG. 3 is a side-view of the operation in FIG. 2A, where the telescopic arm 6 has been extended to create a clearance between the load carrier 11 and the roof of the vehicle 1.

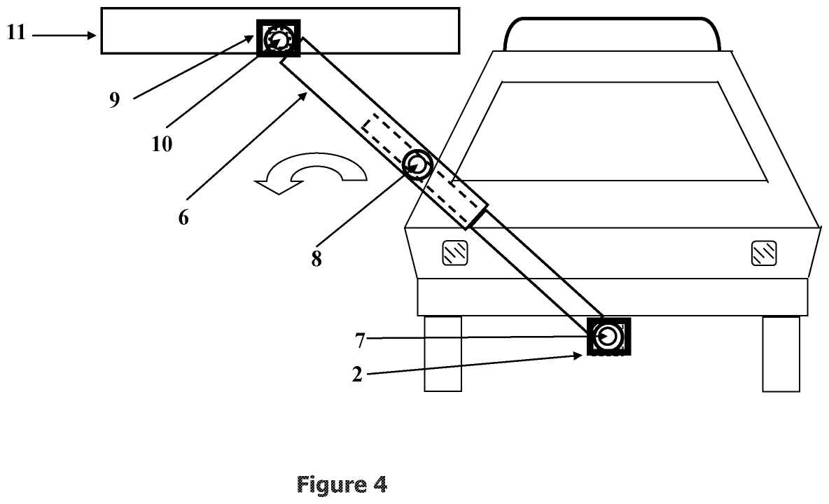

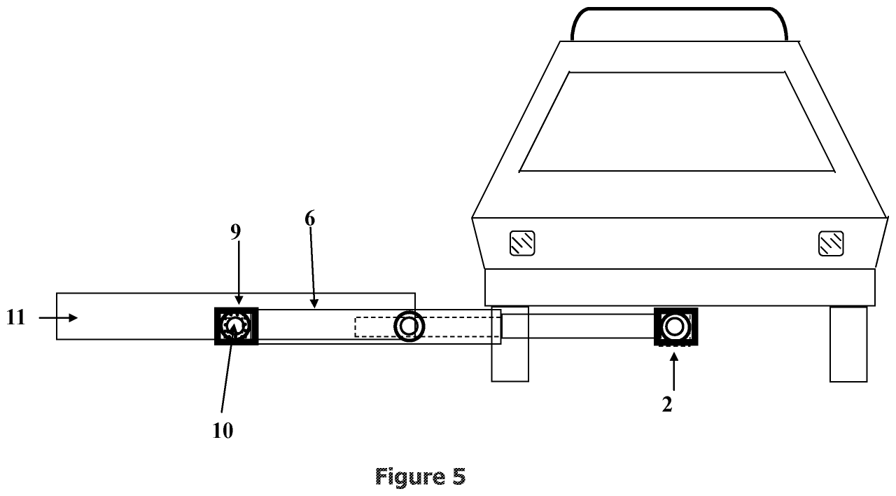

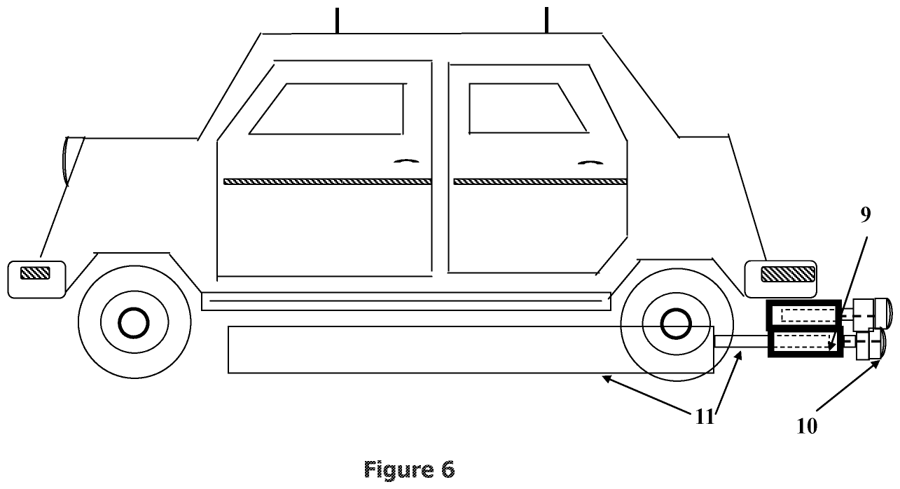

Once a clearance has been established between load carrier 11 and the roof of the vehicle 1, the lift system may be further operated by activating servomotors 7, 10 to rotate the load carrier 11 from the roof of the vehicle to a position substantially near the ground. Servomotors 7, 10 rotate in a synchronized counter-rotational way relative to each other, such that the telescopic arm 6 rotates in either a clockwise or counterclockwise manner while the load carrier 11 maintains a substantially constant orientation relative to the ground, as shown in FIG. 4. During the rotation of telescopic arm 6, the servomotor 8 may be activated or deactivated to further lengthen or shorten the telescopic arm 6 such that the load carrier 11 does not contact the vehicle during the lifting or lowering process. Once the lowering process is complete, as shown in FIG. 5 and FIG. 6, an individual has full access to the load carrier 11 at a location relatively close to the ground. Objects, such as cargo, bikes, kayaks, etc. may be loaded or unloaded onto the load carrier 11 in this position, and the process may be reversed to then lift the cargo or empty load carrier 11 back to the roof of the vehicle.

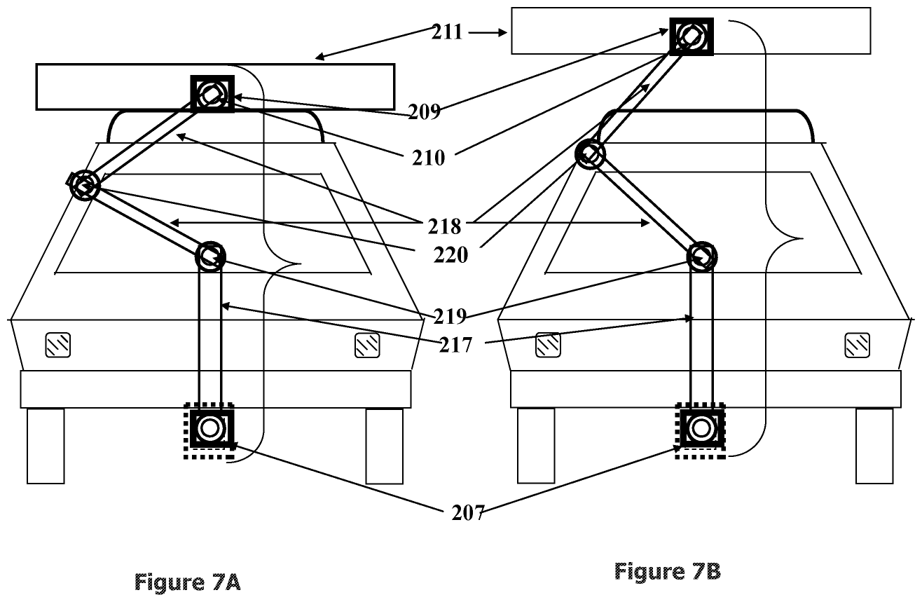

FIG. 7 shows an alternative embodiment of the lift system. In this system, a series of arms 218 are hingedly attached to one another. One end of one of the arms 218 is attached to the main arm 217, and one end of another arm 218 is attached to the connection mechanism 209. The arms 218 may be rotated relative to one another, preferably by at least one servomotor 220, to create a clearance between the load carrier 211 and roof of the vehicle. Servomotors 207, 210, 219, and 220 are coordinated to enable synchronized rotation and counter-rotation such that the load carrier 211 maintains substantially the same orientation relative to the ground. Once enough clearance has been created by rotating arms 218, the main arm 217 may be rotated, preferably by a servomotor 207 attached near the hitch of the vehicle, to lower the load carrier 211 to the ground. This process may be reversed when lifting the load carrier 211 from the ground to the roof of the vehicle.

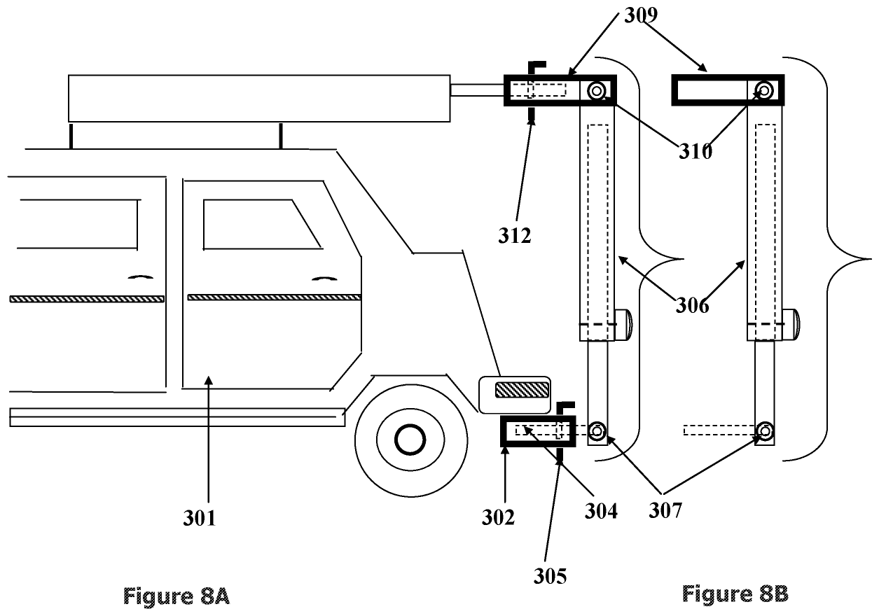

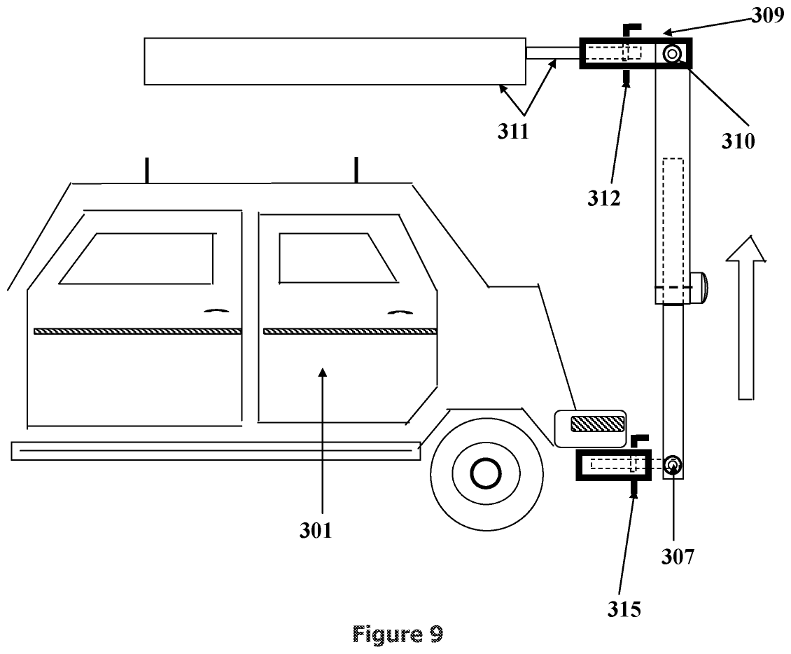

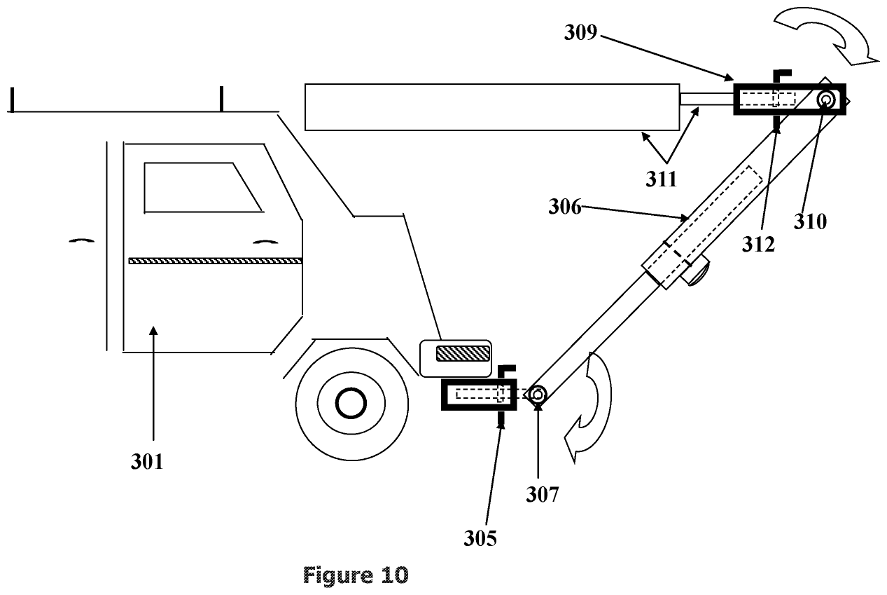

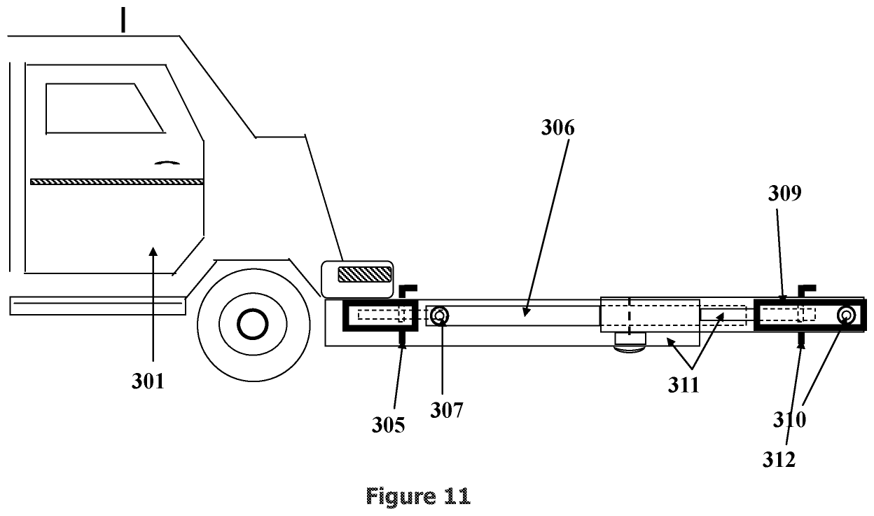

FIG. 8-11 show an alternative embodiment of the lift system. Instead of rotating to the side of a vehicle 301, the servomotor 307 is configured to rotate the telescopic arm 306 such that the load carrier 311 is located substantially behind the vehicle when the load carrier is in a position substantially close to the ground. This may be accomplished by configuring the servomotor 307 to rotate the telescopic arm along a plane substantially parallel to the length of the vehicle 301 and axis of the hitch 302. Likewise, servomotor 310 may be configured to enable synchronized counter-rotation with servomotor 307 to ensure the load carrier 311 maintains substantially the same orientation relative to the ground. Like the previous embodiments, the lift system may be secured to the vehicle by means of a hitch receiver 304 and hitch pin 305. Likewise, the load carrier 311 may be secured to the lift system by means of a connection mechanism 309 and hitch pin 312.

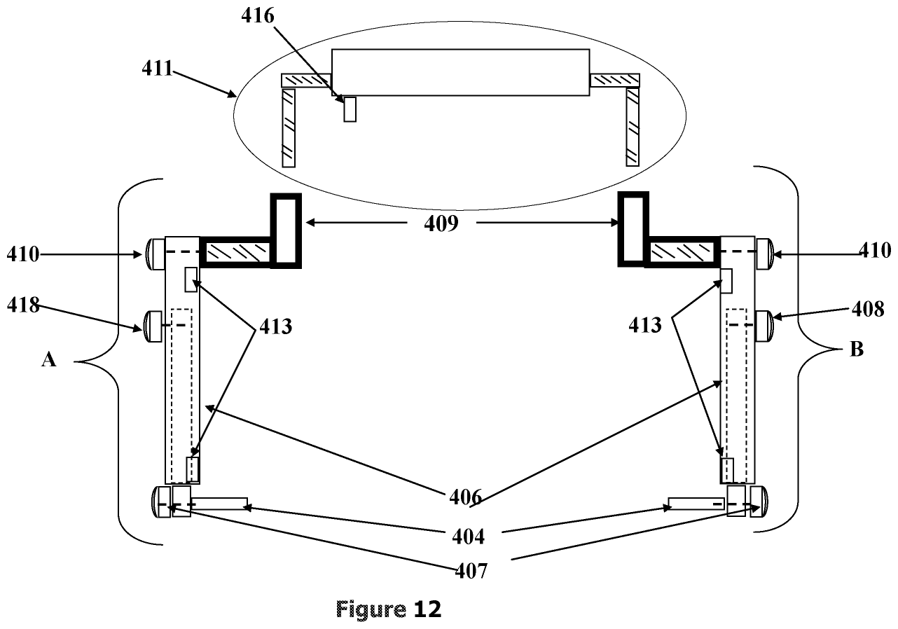

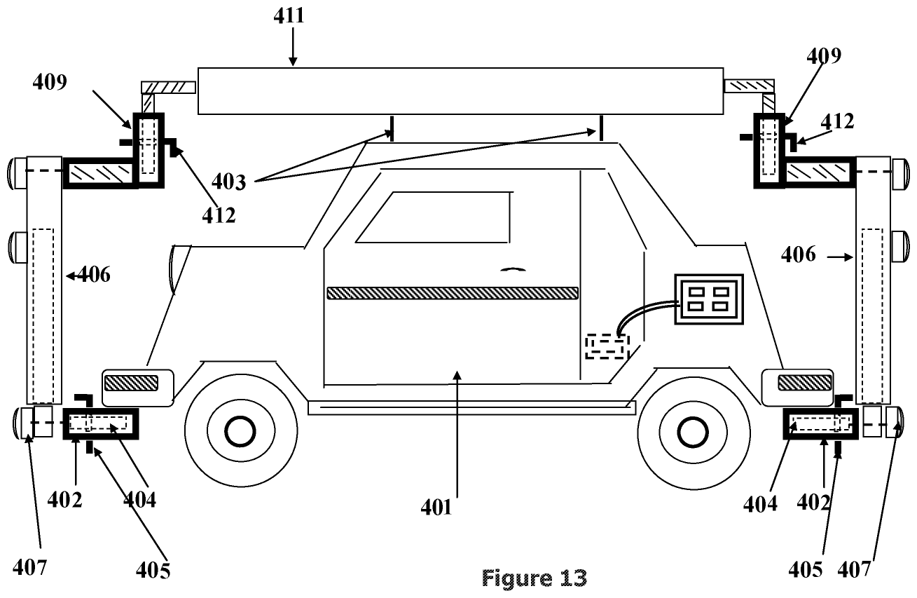

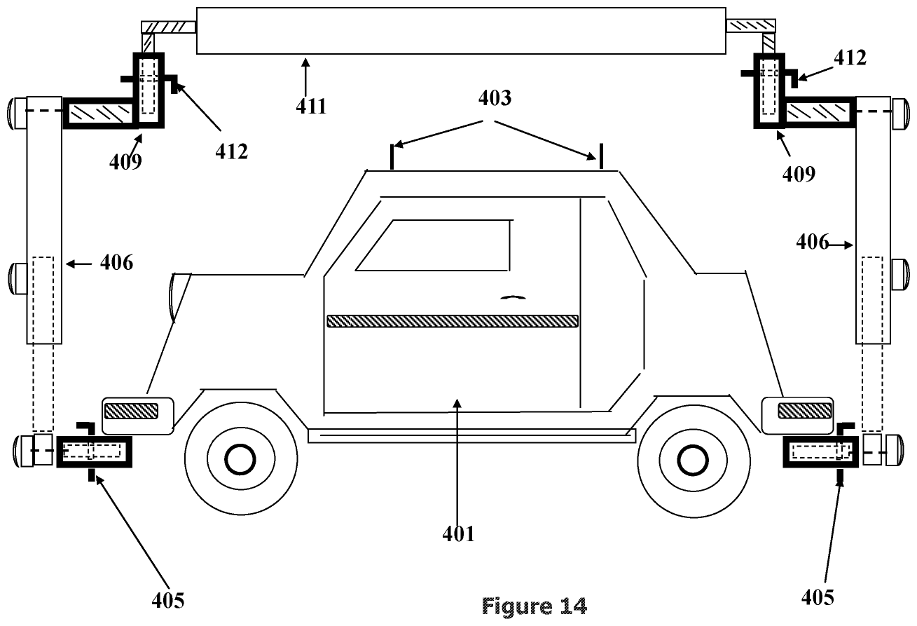

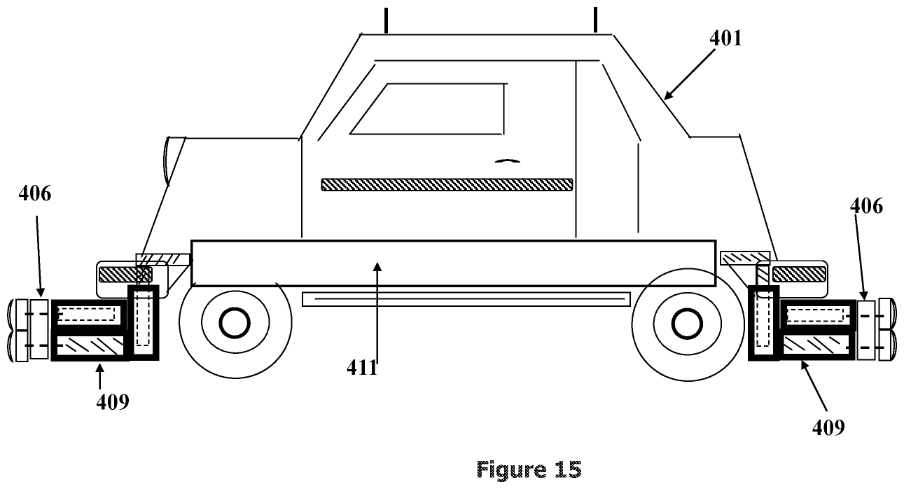

FIG. 12-15 show an alternative embodiment of the lift system, where multiple lift systems may be provided. For instance, one lift system B may be provided for the rear of the vehicle, while another lift system A is provided for the front of the vehicle. Each lift system may have a hitch receiver 404 and hitch pin 405, or some other means of connecting the lift systems A, B to the vehicle. Additionally, each lift system may have servomotors 407 and 410, connection mechanism 409, hitch pin 412, solenoid-operated deadbolts 413, 416, and other associated structure. And while the embodiment shown in FIG. 12-15 show two telescoping embodiments comprising a telescopic arm 406 and servomotor 408, multiple lift systems may be provided for any of the disclosed embodiments. For instance, if two lift systems embodied in FIG. 8-11 are provided, they may both be provided on the rear end of the vehicle. Any two lift systems work together, utilizing synchronized rotation and counter-rotation of the servomotors, to lift at least one load carrier 411 from the ground to the roof of a vehicle 403, and vice versa. However, in order to attach or detach the load carrier 411 to the multiple lift systems, the connection mechanisms must account for the lack of forward/backwards clearance the other embodiments utilize to attach the load carriers to the connection mechanisms. Thus, the connection mechanisms 409 may have an “L” shaped structures that extend the connections vertically rather than horizontally. The load carrier would then have complementary “L” structures that enter or receive the connection mechanisms 409, as shown in FIG. 12-13. In this way, the load carrier 411 may be directly lowered and raised into the two “L” shaped connection mechanisms 409, eliminating the need for horizontal clearance found in the other embodiments.

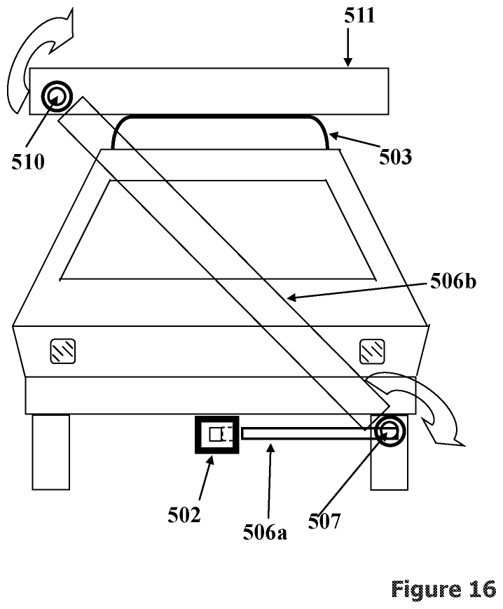

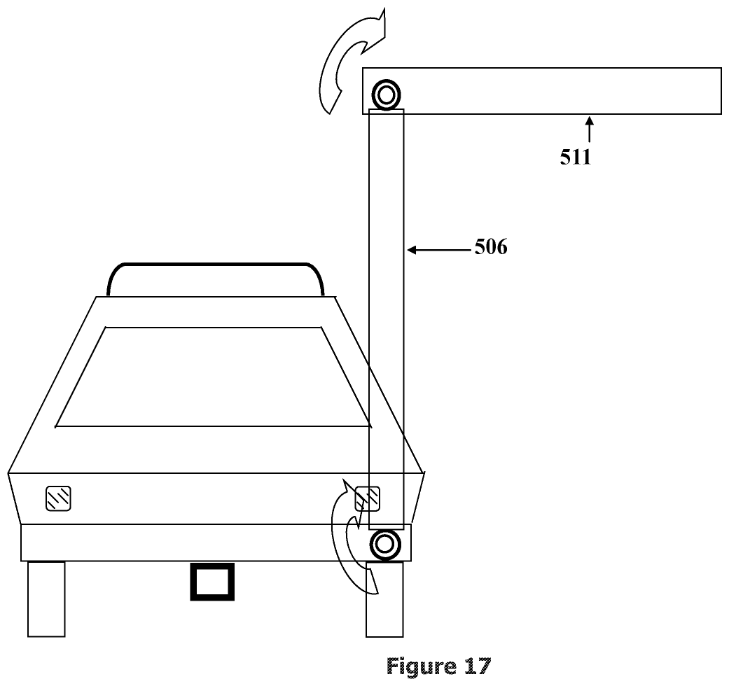

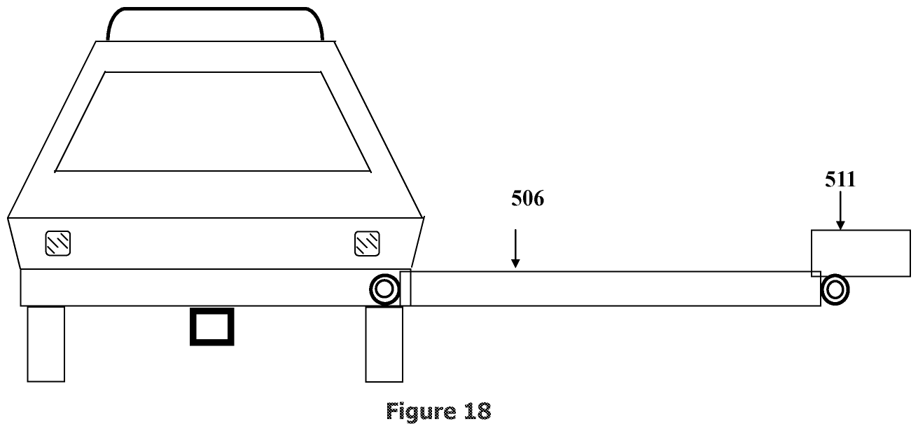

FIG. 16-18 show an alternative embodiment of the lift system, where the clearance between the vehicle 1 and the load carrier 511 is created by offsetting a main arm 506a from the center of the vehicle 1. Such an offset may be established by either having an offset member 506b attached to the hitch 502, as shown in FIG. 16, or by attaching the main arm 506a directly to the vehicle 1 at a location offset from the hitch 502, as shown in FIG. 17. When the load carrier 511 is attached to the roof 503 of the vehicle 501, the main arm 506a does not stand vertically, but stands on a diagonal relative to the ground and vehicle. As a result, when servomotors 507 and 510 rotate in a synchronized counter-rotation, the main arm 506a rotates to a vertical position thereby elevating the load carrier 511 and creating a clearance between the vehicle 503 and load carrier 511, as shown in FIG. 17. The servomotors 507 and 510 continue to rotate until the load carrier 511 is sufficiently near the ground, as shown in FIG. 18.

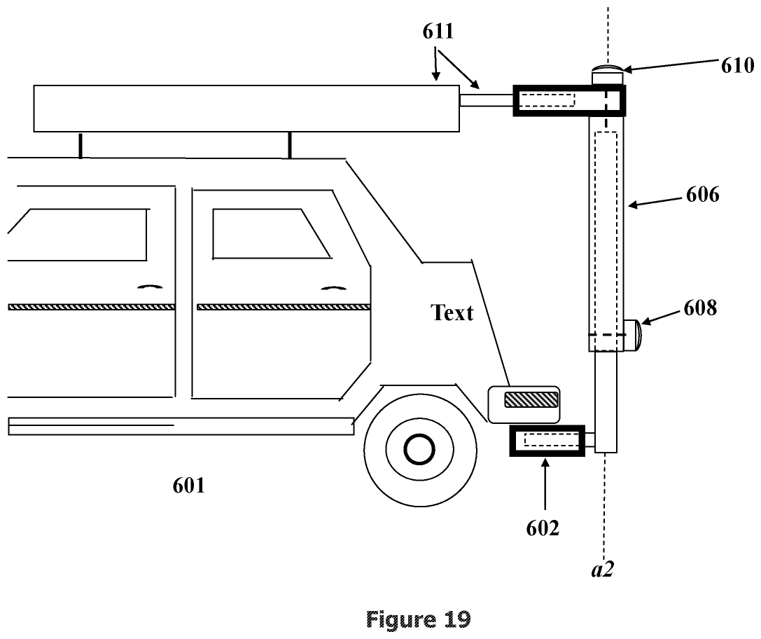

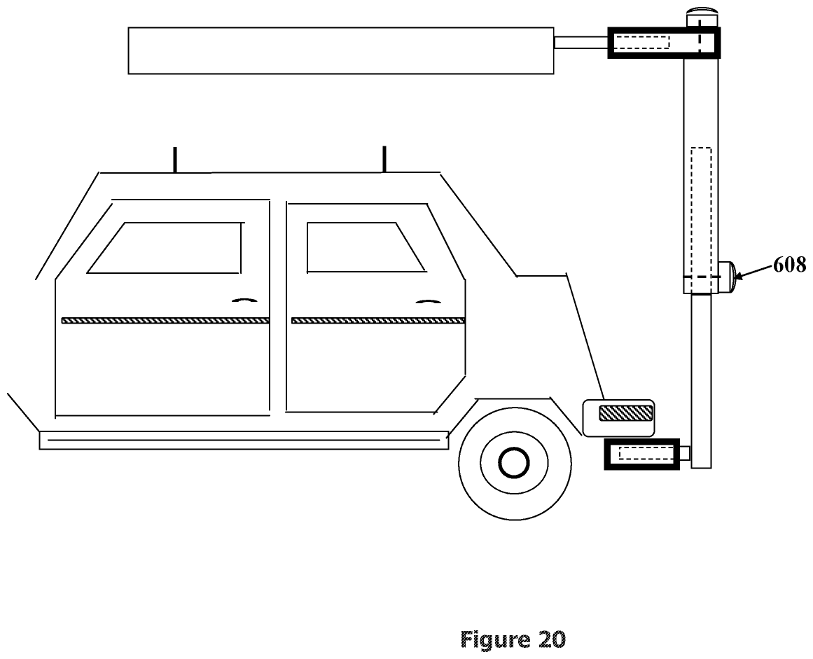

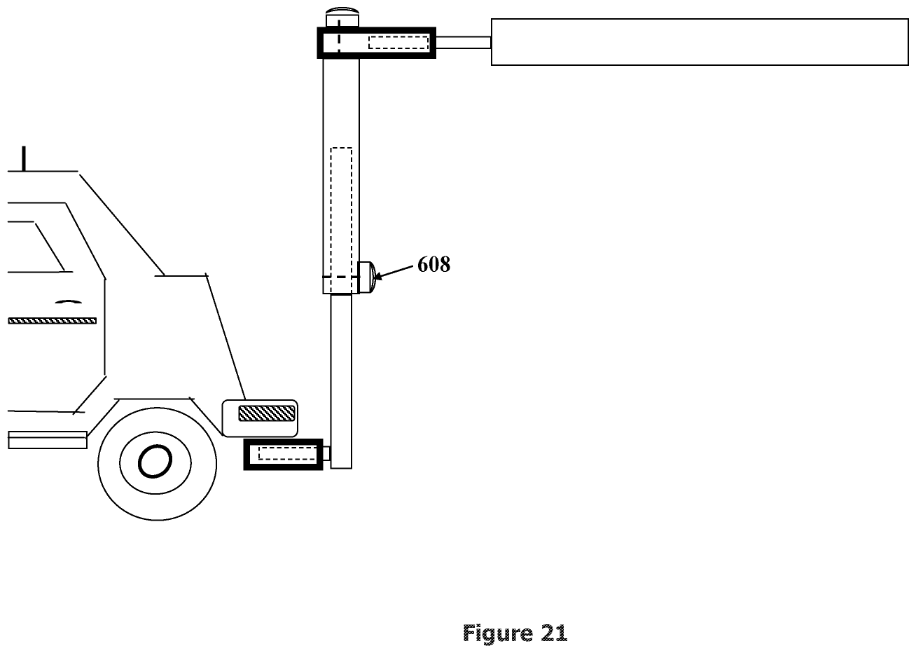

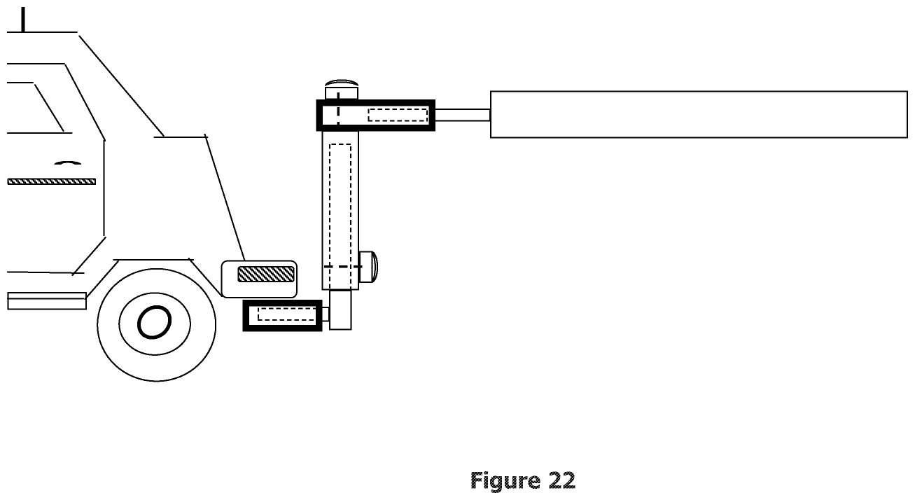

FIG. 19-22 show an alternative embodiment of the lift system, where the lift system creates a horizontal clearance from the roof of the vehicle rather than a vertical clearance. The lift system in FIG. 19-21 may utilize substantially the same structure as the first embodiment in FIG. 1. However, in this embodiment, servomotor 610 is configured to rotate the load carrier 611 about an axis a2 through the member 606, such that the load carrier 611 moves from a position directly above the vehicle 601, to a position substantially behind the vehicle 601 while maintaining its substantially parallel orientation to the ground. In one embodiment, member 606 may be a single rigid member, wherein an optional servomotor 607 may rotate the member 606 to the ground about an axis parallel to the length of the vehicle 601 and hitch 602, like the embodiment in FIG. 1. In another embodiment, member 606 is telescopic, comprising at least two members configured to move relative to one another by means of servomotor 608, wherein the load carrier 611 may be lowered substantially to the ground by telescoping the at least two members, as shown in FIG. 22.

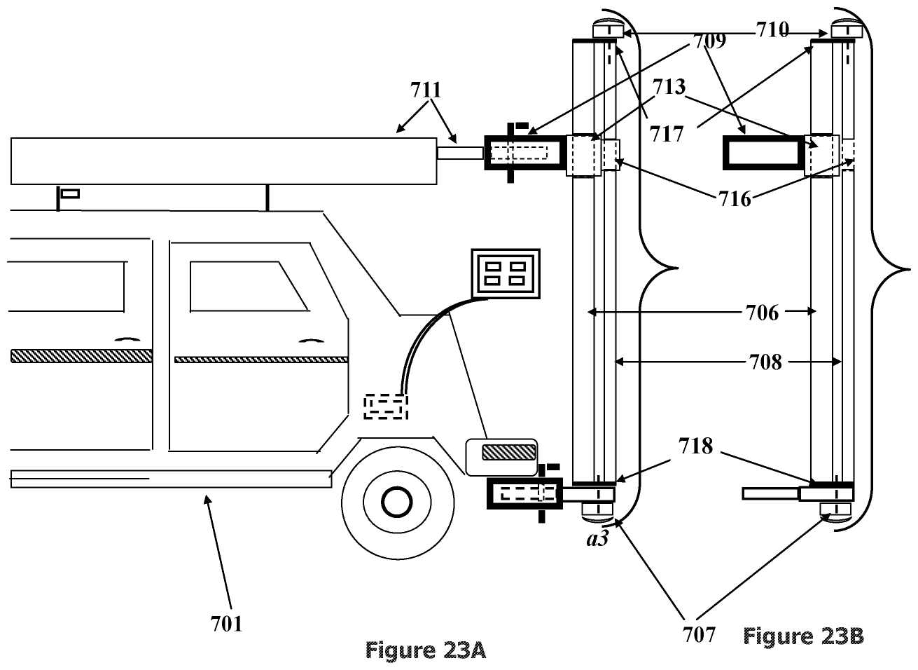

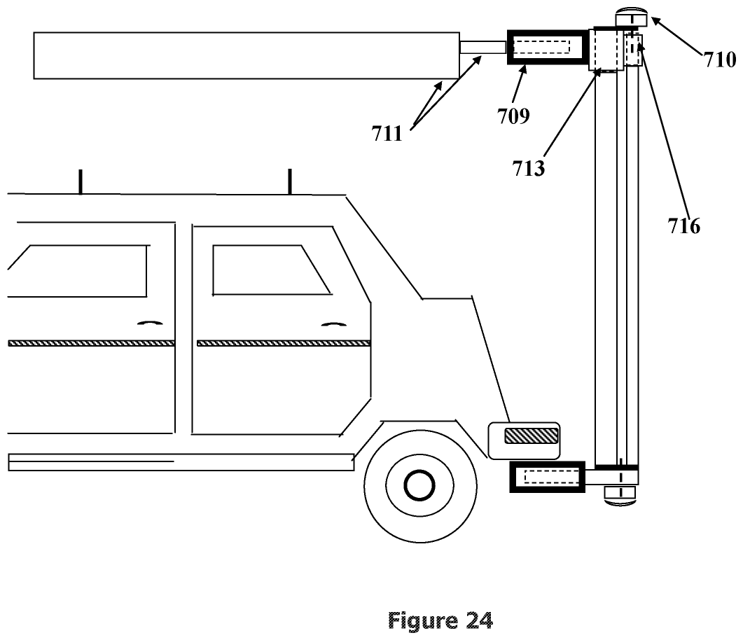

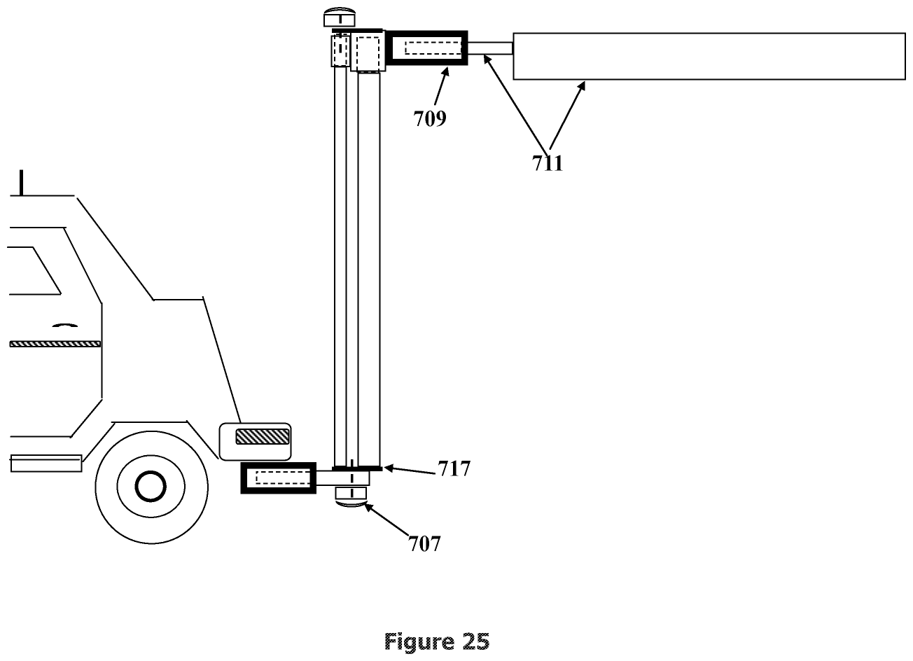

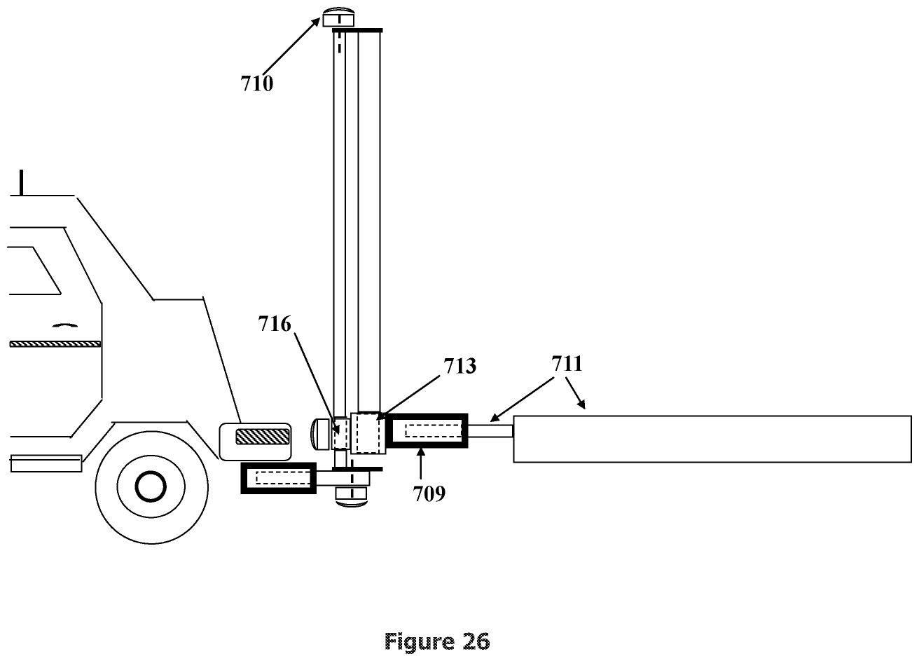

FIG. 23-26 show an alternative embodiment of the lift system of FIG. 19-22, where the lift system creates a horizontal clearance from the roof of the vehicle rather than a vertical clearance. Yet in this embodiment, the interchangeable load carrier 711 is moved between an elevated position as shown in FIG. 25 to a position substantially near the ground as shown in FIG. 26 by rotating a screw mechanism 708, or some other actuating mechanism, via servomotor 710. In this embodiment, the connection mechanism 709 also has a through connection 713, and a threaded connection 716, either integrally or attached together. The threaded connection 716 has threads that complement screw mechanism 708. The through connection 713 slidingly engages member 706, while preventing the entire connection mechanism 709 from rotating. As a result, when screw mechanism 708 rotates, the entire connection mechanism 709 may selectively travel vertically (as rotation of connection mechanism 709 relative to the screw mechanism 708 is inhibited by member 706 and through connection 713). Further, the lift system has end plates 717, 718 to hold the screw mechanism 708, member 706, and other associated structure together. In use, servomotor 707 activates to rotate the connection mechanism 709 (and thus load carrier 711), screw mechanism 708, member 706, and two end plates 717, 718, and all other associated structures as a unit about an axis a3. Thus, the load carrier 711 moves from a position directly above the vehicle 701, to a position substantially behind the vehicle 701 while maintaining its substantially parallel orientation to the ground. Once clear of the vehicle 701, servomotor 710 activates to rotate a screw mechanism 708. The screw mechanism 708 causes threaded connection 716 to move vertically up or down along the threads, depending on the rotational direction of servomotor 710. Through connection 713, connection mechanism 709 and load carrier 711 move vertically with the threaded connection 716 due to their attachment.

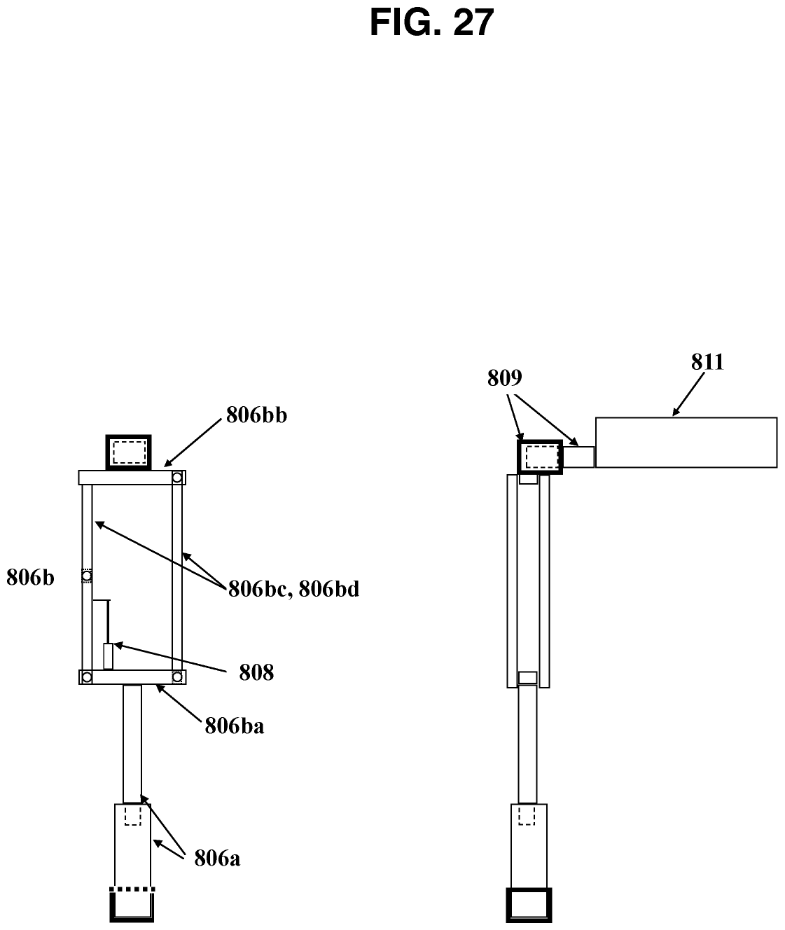

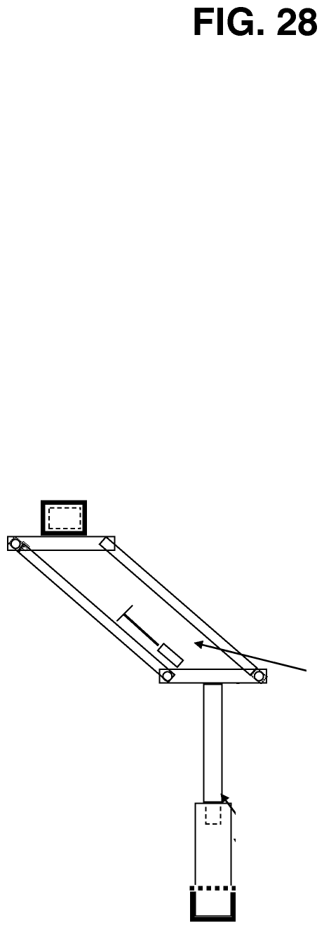

FIG. 27-28 show an alternative embodiment of the invention, where the second member utilizes a parallelogram-type arrangement to create a clearance between the load carrier 811 and vehicle. In this embodiment, the lift arm comprises a main arm 806a and a parallelogram arm 806b. The main arm 806a is capable of selectively raising and lowering the parallelogram arm by any means. The parallelogram arm then comprises two base arms 806ba, 806bb, and two pivot arms 806bc, 806bd. The two pivot arms 806bc, 806bd are hingedly attached between the two base arms 806ba, 806bb. An actuator 808, such as a servomotor, is provided between one or more of the base arm 806ba, 806bb and one or more of the pivot arms 806bc, 806bd in order to rotate the pivot arms 806bc, 806bd relative to the base arms 806ba, 806bb. When rotated, the two base arms 806ba, 806bb remain substantially parallel to each other. The two pivot arms 806bc, 806bd also remain substantially parallel to each other. Therefore, the connection mechanism 809 and load carrier 811 maintain a substantially parallel orientation relative to the ground as the pivot arms 806bc, 806bd are rotated.

The lift system may be made of any suitable material, including but not limited to metals, plastics, composites, or the like. The various components, including the lift system arms, connection mechanisms, or receiver hitch, may be of any shape, including but not limited to circular, square, rectangular, round, hexagonal, or the like. Such components may be solid or hollow in cross-section.

While only some of the embodiments show a locking means to lock the arms of the lift system into relative positions, or to lock the interchangeable load carrier to the roof of a vehicle, any embodiment may employ such locking means. For instance, any lift system may be provided with at least one solenoid-operated dead bolt lock, which could lock the lift system at a particular angle, or the telescopic arm at a particular height. Any interchangeable load carrier may also be provided with at least one solenoid-operated dead bolt to secure the interchangeable load carrier to the roof of the vehicle or vehicle rack. Although solenoid-operated dead bolt locks are envisioned, any other type of locking mechanism may be used. As one non-limited alternative, suction cups may be attached to the bottom of the interchangeable load carrier to secure the load carrier to the roof of the vehicle, even if the vehicle does not have a vehicle rack. Additionally, straps may be provided to further secure the load carrier to the roof of the vehicle.

Further, while only some of the embodiments show a computer-programmable controller comprising a module, any embodiment may employ such control means. As discussed in the first embodiment, the computer-programmable controller may be located in the vehicle, lift system, or any other place, such as a hand-held personal communication device, that would enable an individual to control the lift system to lift or lower the load carrier to or from the roof of the vehicle to the ground. The controller and module may communicate to the lift system, particularly the servomotors, solenoid-operated locks, or any other hardware directly, such as through wires, or through wireless communications, such as infrared, Bluetooth, cellular data, Wi-Fi, radio waves, or any other wireless communication protocol. The controller may have means, such as physical or digital buttons, of interacting with the module. The module may be a CPU and/or other hardware located on the vehicle or lift system, without any means of directly interacting with the module, while the controller is on a hand-held personal communication device, allowing an individual to interact with the module via wireless communication means.

While certain embodiments are disclosed, it would be understood that any of the disclosed ways to create a clearance between the load carrier and vehicle could be combined with any of the disclosed ways to raise or lower the load carrier from its raised height to the ground (and vice versa), and the specific embodiments disclosed are non-limiting examples. Further, although two distinct steps are discussed (i.e. creating a clearance and then lowering the load carrier, or raising the load carrier then eliminating a clearance), the two steps may be performed at the same time (i.e. as the load carrier is lowered, the lift system also increases the clearance).

What is claimed is:

1-32. (canceled)

33. A method of lifting an interchangeable load carrier to and from a roof of a vehicle, comprising the steps of:
providing a lift system comprising:
an attachment mechanism configured to attach the lift system to the vehicle;
a connection mechanism configured to attach the interchangeable load carrier to the lift system;
a lift arm comprising at least a first and second member; at least one actuator;
providing an interchangeable load carrier;
selectively raising or lowering the interchangeable load carrier by either:
(i) creating a clearance between the interchangeable load carrier and the roof of the vehicle while maintaining a substantially constant orientation of the interchangeable load carrier relative to the ground, and
adjusting a vertical height of the interchangeable load carrier from a first height at or above the roof of the vehicle to a height substantially near the ground; or
(ii) adjusting a vertical height of the interchangeable load carrier from a height substantially near the ground to a first height at or above the roof of the vehicle, and
eliminating a clearance between the interchangeable load carrier and the roof of the vehicle while maintaining a substantially constant orientation of the interchangeable load carrier relative to the ground.

34. The method of claim 33, wherein the first member and second member are telescopic, and the step of creating or eliminating a clearance further comprises the step of moving the second member relatively to the first member.

35. The method of claim 34, wherein the step of creating or eliminating a clearance further comprises activating the actuator, thereby moving the second member telescopically relatively to the first member.

36. The method of claim 33, wherein the second member comprises a plurality of arms hingedly attached to one another and each end of each of the plurality of arms is attached to an actuator,
wherein the step of creating or eliminating a clearance further comprises the step of moving the plurality of arms relative to each other, thereby increasing or decreasing the overall length of the lift arm.

37. The method of claim 33, wherein the second member comprises a first and second base arm and a first and second pivot arm;
wherein the step of creating or eliminating a clearance further comprises the step of moving the first and second pivot arm relative to the first and second base arm, while the first and second pivot arm remain substantially parallel, and the first and second base arm remain substantially parallel.

38. The method of claim 33, wherein the step of creating or eliminating a clearance between the interchangeable load carrier and the roof of the vehicle comprises the step of rotating the connection mechanism about an axis normal to the ground.

39. The method of claim 38, wherein the first member and second member are telescopic, such that relative movement between the first and second member increase or decrease the overall length of the lift arm.

40. The method of claim 38, wherein the first member has an axis and comprises exterior threads, and the connection mechanism further comprises a first through-hole with complementary interior threads and a second through-hole;
wherein the threads of first member engage the complementary threads of the first through-hole;
wherein the step of selectively raising or lowering the interchangeable load carrier further comprises the step of rotating the first member about the axis, thereby moving the connection mechanism vertically.

41. The method of claim 33, wherein the step of selectively raising or lowering the interchangeable load carrier further comprises moving the first member relative to the attachment mechanism.

42. The method of claim 41, wherein the first member moves along a plane substantially normal to the axis of the attachment mechanism.

43. The method of claim 41, wherein the first member moves along a plane substantially parallel to the axis of the attachment mechanism.

44. The method of claim 33, wherein the step of selectively raising or lowering the interchangeable load carrier further comprises the step of rotating the connection mechanism relative to the second member.

45. The method of claim 44, wherein the step of selectively raising or lowering the interchangeable load carrier further comprises the step rotating the lift arm relative to the attachment means in a first direction, and rotating the connection mechanism relative to the lift arm in a second direction opposite the first direction.

46. The method of claim 45, wherein the step of rotating the lift arm relative to the attachment means comprises the step of activating a second actuator, and the step of rotating the connection mechanism relative to the lift arm comprises the step of activating a third actuator.

47. The method of claim 46, wherein the steps of activating the second and third actuator occur simultaneously thereby maintaining a substantially constant orientation of the interchangeable load carrier relative to the ground as the interchangeable load carrier is selectively raised or lowered.

48. The method of claim 45, wherein the first member and second member are telescopic; wherein the step of creating or eliminating a clearance further comprises the step of moving the second member relatively to the first member by activing an actuator.

49. The method of claim 48, wherein the first member moves along a plane substantially normal to the axis of the attachment mechanism.

50. The method of claim 48, wherein the first member moves along a plane substantially parallel to the axis of the attachment mechanism.

51. The method of claim 45, wherein the second member comprises a plurality of arms hingedly attached to one another and each end of each of the plurality of arms is attached to an actuator;
wherein the step of creating or eliminating a clearance further comprises the step of moving the plurality of arms relative to each other, thereby increasing or decreasing the overall length of the lift arm.

52. The method of claim 33, the method further comprising the step of activating a lock to selectively secure or unsecure the interchangeable load carrier to the vehicle.
